(19) United States
(12) Patent Application Publication
(10) Pub. No.: US 2026/0081516 A1
(43) Pub. Date: Mar. 19, 2026

(54) SYSTEM AND METHOD FOR HIGH EFFICIENCY WIDE-VOLTAGE-GAIN POWER CONVERSION

(71) Applicant: ARIZONA BOARD OF REGENTS ON BEHALF OF ARIZONA STATE UNIVERSITY, Scottsdale, AZ (US)

(72) Inventor: Mike RANJRAM, Tempe, AZ (US)

(21) Appl. No.: 19/109,903

(22) PCT Filed: Sep. 11, 2023
(86) PCT No.: PCT/US2023/073845

§ 371 Date: Mar. 7, 2025

Related U.S. Application Data
(60) Provisional application No. 63/405,374, filed on Sep. 9, 2022.

(51) Int. Cl. H02M 1/088; H01F 21/02; H01F 27/34; H02M 3/335

(52) U.S. Cl. CPC H02M 1/088; H01F 21/02; H01F 27/34; H02M 3/33571; H02M 3/33573; H02M 3/33584

(57) ABSTRACT

A high efficiency wide-voltage-gain power conversion system and method is disclosed. The system includes a variable-inverter-rectifier-transformer (VIRT) having four pairs of switches forming four half-bridges. Each pair of switches has a top and bottom switch, with the top switch being in one state of “on” and “off” and the bottom switch being in the other state. The states of the four pairs is described by a vector associated with a segment voltage output by the VIRT. The system also includes a converter having a transformer communicatively coupled to the VIRT such that cycling the VIRT through a sequence of vectors generates a waveshape that drives a flux inside a center post of the transformer. The VIRT interfaces with a first voltage, and the converter interfaces with a second. At least one of the input and output voltages varies across a wide voltage range.

### RELATED APPLICATIONS

This application claims the benefit of U.S. provisional patent application 63/405,374, filed Sep. 9, 2022, titled “System and Method for High Efficiency Wide-Voltage-Gain Power Conversion,” the entirety of the disclosure of which is hereby incorporated by this reference.

### TECHNICAL FIELD

Aspects of this document relate generally to wide-voltage-gain power conversion.

### BACKGROUND

Power converters play a crucial role in transitioning electrical power between various voltage or current levels, transforming electrical energy into a form suitable for specific applications. Some applications have very particular requirements. For example, datacenters and electric vehicles often require high voltage step-down conversion capable of handling significantly variable input and output voltages.

LLC converters, a commonly used converter topology, are often deployed for wide output voltage range conversion. These converters can be switched at high frequencies, achieve soft-switching, and can be designed to facilitate high step-up or step-down conversion ratios by controlling the number of turns on the transformer.

Despite significant advancements in semiconductor switch technologies, the miniaturization and efficiency of power converters, particularly conventional converters for broad voltage range applications, have lagged. The main limiting factor is the size and volume of passive components, notably magnetic ones such as transformers and inductors.

Magnetic components, integral to many converter topologies including LLC converters, pose a challenge to miniaturization due to the issue of core loss. As these components are reduced in size, core loss tends to increase, impacting the efficiency of the power converter.

Applications that require substantial voltage step-up or step-down, such as datacenters, exacerbate this core loss problem. The larger the conversion ratios, the greater the core loss, which in turn limits the power converter's overall efficiency and potential for miniaturization.

Furthermore, these applications often necessitate operation across a broad voltage range, leading to additional design challenges and performance degradation. For instance, an LLC converter is typically most efficient when operating at or near its resonant frequency (fₙ=1). For a fixed input voltage, the frequency must be reduced to increase the output voltage. To decrease the output voltage, the frequency must be increased. This variation in frequency to accommodate wide voltage ranges imposes a challenging design constraint on the bulky and lossy transformer that dominates the LLC converter's volume and size.

### SUMMARY

According to one aspect, a wide-voltage-gain power conversion system includes a Variable-Inverter-Rectifier-Transformer (VIRT) having four pairs of switches forming four half-bridges, each pair of switches having a top switch and a bottom switch with the top switch being in one state of “on” and “off” and the bottom switch being in the other state of “on” and “off”. The states of the four pairs of switches is described by a vector belonging to a plurality of vectors. Each vector of the plurality of vectors is associated with a segment voltage that is output by the VIRT. The system also includes an LLC converter including a transformer, the transformer of the LLC converter communicatively coupled to the VIRT such that cycling the VIRT through a sequence of vectors having at least two vectors generates a voltage waveshape that drives a controlled flux inside a center post of the transformer. The VIRT receives an input voltage. The converter produces an output voltage. At least one of the input voltage and the output voltage varies across a wide voltage range. The wide voltage range is defined by an upper limit and a lower limit, with the upper voltage limit being at least 1.2 times the lower voltage limit and the converter carrying power that is substantially constant for all of the voltages in the wide voltage range.

Particular embodiments may comprise one or more of the following features. The sequence of vectors may be associated with at least three different segment voltages such that the voltage waveshape is multi-level. The sequence of vectors may include at least six vectors. Each vector in the sequence of vectors may be unique. The sequence of vectors may be [0001], [1001], [1000], [1110], [0110], [0111]. The first, third, fourth, and/or sixth vector of the sequence of vectors may have a first length. The second and/or fifth vectors of the sequence of vectors may have a second length.

According to another aspect of the disclosure, a wide-voltage-gain power conversion system includes a Variable-Inverter-Rectifier-Transformer (VIRT) having four pairs of switches forming four half-bridges. Each pair of switches has a top switch and a bottom switch with the top switch being in one state of “on” and “off” and the bottom switch being in the other state of “on” and “off”. The states of the four pairs of switches is described by a vector belonging to a plurality of vectors, each vector of the plurality of vectors being associated with a segment voltage that is output by the VIRT. The system also includes a converter having at least one transformer, the at least one transformer of the converter communicatively coupled to the VIRT such that cycling the VIRT through a sequence of vectors generates a voltage waveshape that drives a controlled flux inside a center post of the at least one transformer. The VIRT interfaces with a first voltage. The converter interfaces with a second voltage. At least one of the first voltage and the second voltage varies across a wide voltage range.

Particular embodiments may comprise one or more of the following features. The converter may be an LLC converter. The sequence of vectors may be associated with at least three different segment voltages such that the voltage waveshape is multi-level. Each vector in the sequence of vectors may be unique. The sequence of vectors may include more than two vectors. The sequence of vectors may include at least six vectors. The sequence of vectors may be [0001], [1001], [1000], [1110], [0110], [0111]. The first, third, fourth, and/or sixth vector of the sequence of vectors may have a first length. The second and/or fifth vectors of the sequence of vectors may have a second length. The wide voltage range may be defined by an upper limit and a lower limit. The upper limit may be at least 1.2 times the lower limit. An output voltage may be produced at a power that may be substantially constant for all of the voltages across the wide voltage range. The upper limit may be at least 1.8 times the lower limit. The first voltage may be an input voltage received by the VIRT, and the second voltage may be an output voltage produced by the converter. The system may further include a second VIRT communicatively coupled to the converter such that the converter interfaces with the second voltage through the second VIRT. The first voltage may vary across a first wide voltage range. The second voltage may vary across a second wide voltage range.

According to yet another aspect of the disclosure, a method for wide-voltage-gain power conversion includes receiving the input voltage at a Variable-Inverter-Rectifier-Transformer (VIRT), the VIRT comprising four pairs of switches forming four half-bridges. Each pair of switches has a top switch and a bottom switch with the top switch being in one state of “on” and “off” and the bottom switch being in the other state of “on” and “off”. The states of the four pairs of switches is described by a vector belonging to a plurality of vectors, each vector of the plurality of vectors being associated with a segment voltage that is output by the VIRT. The method also includes generating a voltage waveshape by cycling the VIRT through a sequence of vectors, the voltage waveshape being composed of the segment voltage of each vector on the sequence of vectors. The sequence of vectors is cycled over a period, with each vector of the sequence of vectors being active for a length in the period. The method includes applying the voltage waveshape generated by the VIRT to a converter. The converter is communicatively coupled to the VIRT and includes at least one transformer. The voltage waveshape drives a controlled flux inside a center post of the transformer such that an output voltage is produced. The method also includes dynamically reducing core loss within the transformer across a wide voltage range by modifying the length of at least one vector in the sequence of vectors, altering the voltage waveshape and thereby reducing a flux density within the transformer. At least one of the input voltage and the output voltage varies across the wide voltage range.

Particular embodiments may comprise one or more of the following features. The converter may be an LLC converter. The sequence of vectors may be associated with at least three different segment voltages such that the voltage waveshape is multi-level. Each vector in the sequence of vectors may be unique. The sequence of vectors may include more than two vectors. The period may be held constant during the modification of the length of at least one vector in the sequence of vectors. The sequence of vectors may include at least six vectors. The sequence of vectors may be [0001], [1001], [1000], [1110], [0110], [0111]. The first, third, fourth, and/or sixth vector of the sequence of vectors may have a first length. The second and/or fifth vectors of the sequence of vectors may have a second length. The wide voltage range may be defined by an upper limit and a lower limit. The upper limit may be at least 1.2 times the lower limit. The output voltage may be produced at a power that may be substantially constant for all of the voltages across the wide voltage range. The upper limit may be at least 1.8 times the lower limit.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1 is a schematic view of an LLC converter circuit;

FIGS. 2A and 2B are system views of two embodiments of a high efficiency wide-voltage-gain power conversion system;

FIG. 3 is a schematic view of a Variable-Inverter-Rectifier-Transformer (VIRT) structure;

FIGS. 4A-4C are model circuit views of high efficiency wide-voltage-gain power conversion systems, each comprising a VIRT structure and a converter;

FIG. 5 is a table of vectors that define the states of a VIRT structure;

FIG. 6 is a voltage waveshape generated by cycling a VIRT through a sequence of vectors; and

FIG. 7 is a table of performance data for a specific embodiment.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Power converters play a crucial role in transitioning electrical power between various voltage or current levels, transforming electrical energy into a form suitable for specific applications. Some applications have very particular requirements. For example, datacenters and electric vehicles typically require high voltage step-down conversion capable of handling significantly variable input and output voltages.

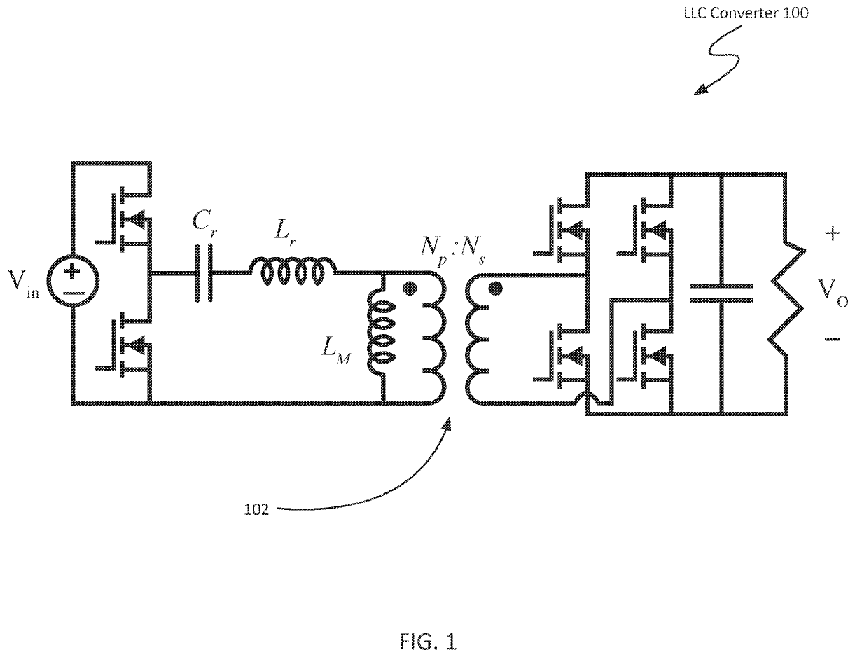

LLC converters, a commonly used converter topology, are often deployed for wide output voltage range conversion. These converters can be switched at high frequencies, achieve soft-switching, and can be designed to facilitate high step-up or step-down conversion ratios by controlling the number of turns on the transformer. FIG. 1 shows a schematic view of a non-limiting example of an LLC converter 100 comprising a transformer 102.

Despite significant advancements in semiconductor switch technologies, the miniaturization and efficiency of power converters, particularly conventional converters for broad voltage range applications, have lagged. The main limiting factor is the size and volume of passive components, notably magnetic ones such as transformers and inductors.

Magnetic components, integral to many converter topologies including LLC converters, pose a challenge to miniaturization due to the issue of core loss. As these components are reduced in size, core loss tends to increase, impacting the efficiency of the power converter.

Applications that require substantial voltage step-up or step-down, such as datacenters, exacerbate this core loss problem. The larger the conversion ratios, the greater the core loss, which in turn limits the power converter's overall efficiency and potential for miniaturization.

Furthermore, these applications often necessitate operation across a broad voltage range, leading to additional design challenges and performance degradation. For instance, an LLC converter is typically most efficient when operating at or near its resonant frequency (fₙ=1). For a fixed input voltage, the frequency must be reduced to increase the output voltage. To decrease the output voltage, the frequency must be increased. This variation in frequency to accommodate wide voltage ranges imposes a challenging design constraint on the bulky and lossy transformer that dominates the LLC converter's volume and size.

As frequency is increased, voltage is decreased, which causes flux density in the transformer to decrease. The Steinmetz equation provides an approximation of core loss density in a material for sinusoidal excitations

$${P}_{v} = k {f}^{α} {B}^{β}$$

Where k is a material constant, f is the operating frequency, and B is the peak flux density. In high performing materials α≈2 while β≈3. This means that if B decreases for increasing f, then core loss drops significantly. Similarly, if B increases with decreasing f, then core loss increases significantly. This core loss variation limits the efficiency and size of the conventional LLC converter in wide range applications.

Contemplated herein is a system and method for high efficiency wide-voltage-gain power conversion. According to various embodiments, the contemplated system is able to convert power with wide input and/or output voltage ranges having high step-up or step-down ratios with greater efficiency and in smaller sizes than conventional power converter technologies.

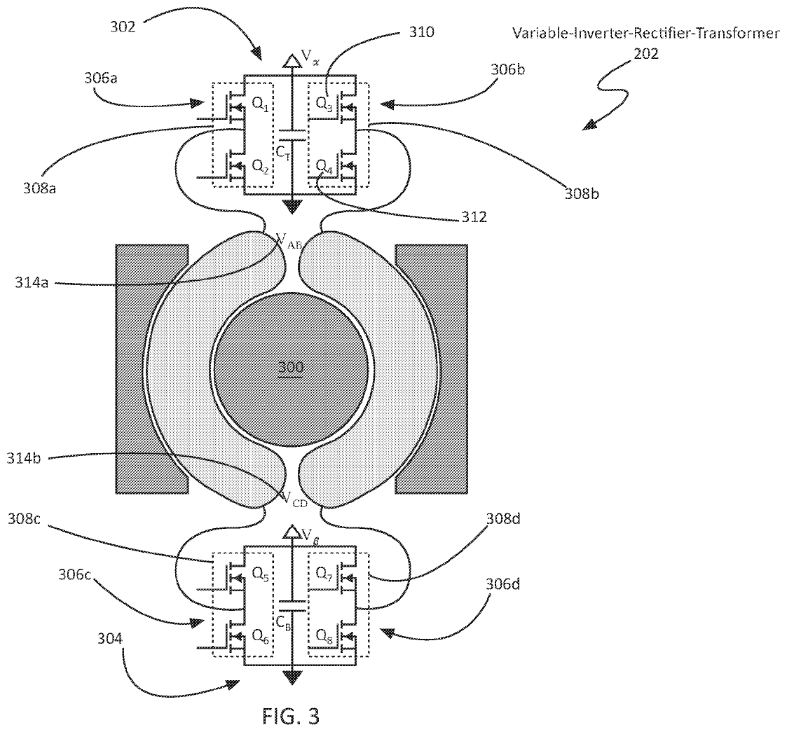

This is made possible through the use of a Variable-Inverter-Rectifier-Transformer (VIRT), which is a novel hybrid electronic and magnetic structure that integrates power converters directly into the windings of a transformer. According to various embodiments, by activating modes or states in the VIRT that are not normally used in the typical applications for VIRT (e.g., fractional turn ratios, dynamic turn ratio, etc.), it can be used to generate a voltage waveshape that, when fed to a converter, reduces core loss in the transformer. The VIRT will be discussed in detail with respect to FIG. 3, below.

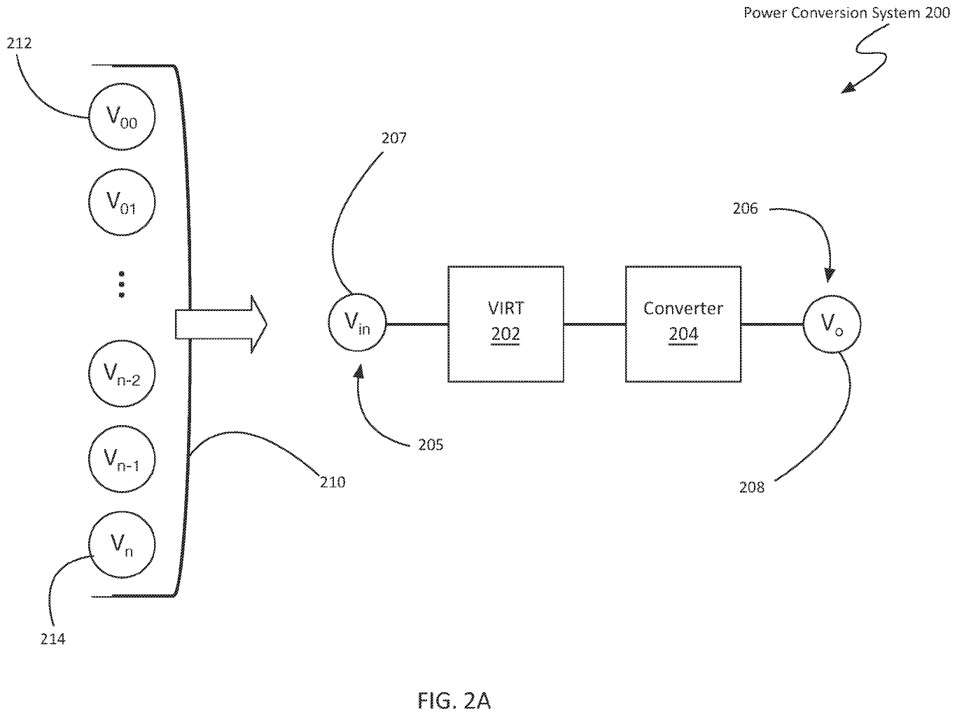

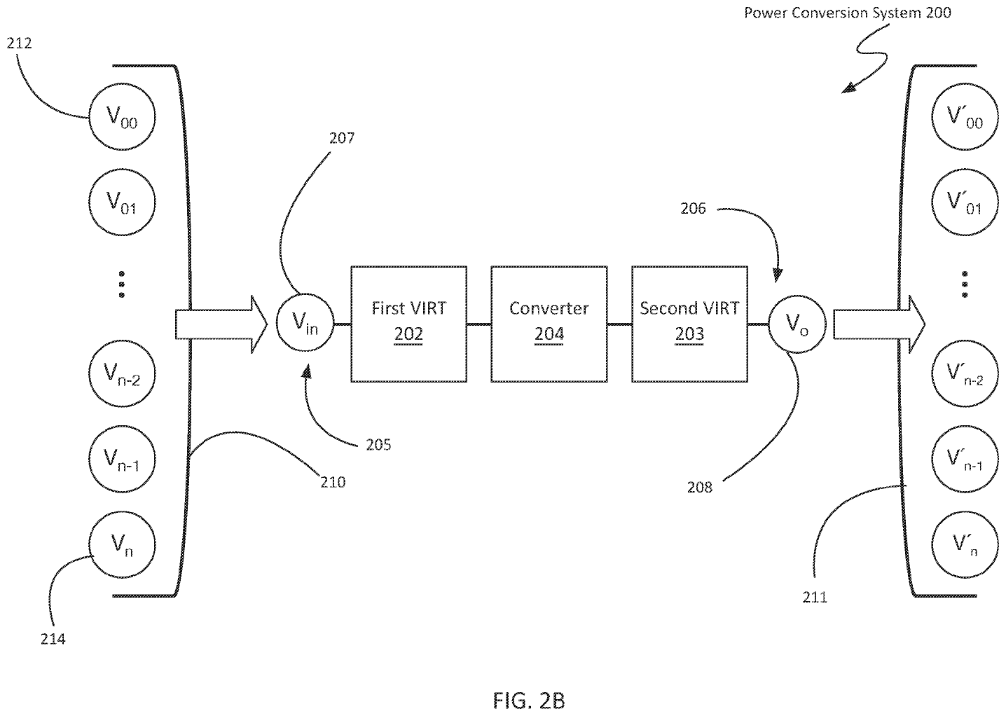

FIGS. 2A and 2B are schematic views of non-limiting examples of a high efficiency wide-voltage-gain power conversion system. As shown, the power conversion system 200 (or simply system 200) comprises at least one Variable-Inverter-Rectifier-Transformer 202 (or VIRT 202) communicatively coupled with a converter 204. In the non-limiting example shown in FIG. 2A, the VIRT 202 interfaces to a first voltage 205 and the converter interfaces to a second voltage 206. According to various embodiments, the contemplated system is bidirectional; which interface is the input and which is the output depends upon the direction power is flowing. For example, in some embodiments including the non-limiting example shown in FIG. 2A, the VIRT 202 receives an input voltage 207, and the converter 204 produces an output voltage 208. In other embodiments, the converter 204 receives an input voltage 207 and the VIRT 202 produces an output voltage 208. It should be noted that the examples disclosed herein are non-limiting; the application of labels such as “input” and “output”, in these bidirectional embodiments of the contemplated system are not to be taken as limitations, but rather as context for a particular example.

As shown, in some embodiments, the input voltage 207 may vary across a wide voltage range 210. It should be noted that while the non-limiting example shown in FIG. 2A, as well as many of the specific embodiments discussed herein, is directed to dealing with a wide voltage range 210 for the input voltage 207, it should not be construed as a limitation. In some other embodiments the output voltage 208 may vary across a wide voltage range 210.

In still other embodiments, both the input voltage 207 and the output voltage 208 may vary across wide voltage ranges 210, and not necessarily across the same range 210. FIG. 2B shows a non-limiting example of a high efficiency wide-voltage-gain power conversion system 200 whose input voltage 207 varies across a first wide voltage range 210 and output voltage 208 varies across a second wide voltage range 211. This is made possible by a second VIRT 203 through which the converter 204 interfaces to the second voltage 206. In some embodiments the first wide voltage range 210 may be the same as the second wide voltage range 211. In other embodiments, the two ranges may be different.

The main challenge addressed by the contemplated system 200 and method is that wide conversion ratios can impose highly disparate operating waveforms on the transformer in conventional conversion systems, yielding wide changes in copper loss and core loss over the operating regime. However, flux density can be controlled by controlling the waveshape fed into the LLC converter 100, and the VIRT 202 provides that control over the waveshape. Thus, a wide range of output voltages can be achieved in the contemplated high efficiency, low volume design.

In some embodiments, there is a trade-off in coupling the VIRT 202 with the LLC, in that it introduces higher conduction loss. However, these losses happen incrementally at the third harmonic and are more manageable than increases in the fundamental. This is because conduction losses go as I²R, which means that for the same resistance seen by both harmonics, the third harmonic produces only a fraction of the loss.

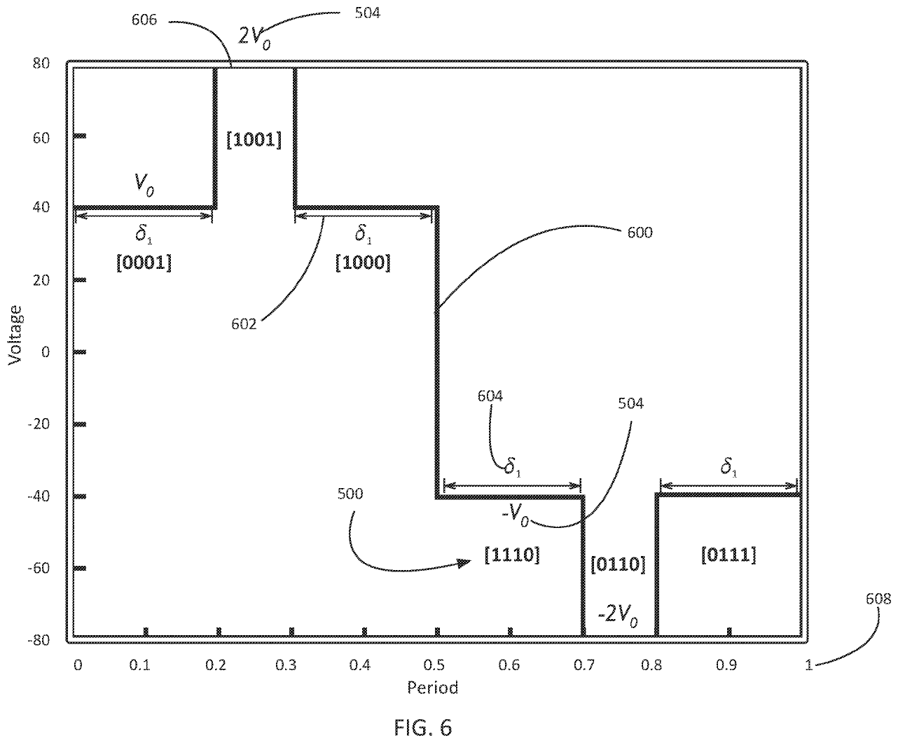

As shown, the contemplated system 200 comprises a converter 204 that includes a transformer 102. According to various embodiments, the transformer 102 of the converter 204 is communicatively coupled to the VIRT 202 such that a voltage waveshape generated by the VIRT 202 drives a controlled flux inside the center post of the transformer 102. The voltage waveshape will be discussed in greater detail with respect to FIG. 6, below.

According to various embodiments, the converter 204 may be an LLC converter 100. While much of the following discussion is focused on using a VIRT 202 to manipulate the waveform being applied to an LLC converter 100, other embodiments use the VIRT 202 in conjunction with other converters 204 that connect a transformer 102 to a rectifier or inverter including, but not limited to, the dual active bridge. The contemplated system may be adapted for use with any isolated converter topology. Furthermore, different rectifier structures, such as half-bridge or center-tapped, can be employed to achieve different waveshape relationships, with the key benefit that they can be made multi-level, as seen in embodiments discussed herein.

As mentioned above, the contemplated system 200 for high efficiency wide-voltage-gain power conversion may be advantageous for use in high power applications dealing with input and output voltages that may vary across a wide voltage range 210. One example is electric vehicles, which have wide voltage ranges due to battery topology (e.g., multiple batteries in series, etc.), battery charging requirements (e.g., different fast charging protocols, etc.), and the state of the battery charge (i.e., voltage of lithium-ion batteries varies widely depending on state of charge), among other reasons. As a specific, non-limiting example, an electric car may require the conversion of 250-450V coming from the traction battery to 10.5-15V for the auxiliary battery.

Another example is data centers, which can require wide voltage ranges for a variety of reasons (e.g., dynamic voltage scaling based on computing load, high voltage distribution to reduce power loss being converted to much lower voltage server racks, etc.). As a specific, non-limiting example, the Open Compute Project's version 2 specification pointed to a wide 40-60V bus voltage. As another non-limiting example, the Open Compute v3 specification allows for higher DC bus voltage ripple for miniaturizing the buffer capacitor. Those skilled in the art will recognize that the contemplated system and method may be adapted for use in other applications for high efficiency, low volume power converters 204.

According to various embodiments, the wide voltage range 210 can be described as a range bound by an upper limit 212 and a lower limit 214 (inclusively). At least one of the input voltage 207 and the output voltage 208 varies across a wide voltage range 210. Put differently, the gain variability provided by waveshape control can be used to accommodate wide output voltage ranges, wide input voltage ranges, or a mix of wide input and output voltage ranges, according to various embodiments.

In the context of the present description and the claims that follow, “wide voltage range” refers to a range of voltages that may be defined as a range of voltages chosen such that the quotient of the upper limit 212 and the lower limit 214 is greater than or equal to a threshold, while the converter 204 carries constant or substantially constant (i.e., within 20%) power for all the voltages across said range. In other words, the variation in losses across that range is held below a certain level. As a specific, non-limiting example, in some embodiments the losses across the entire wide voltage range are less than 3%.

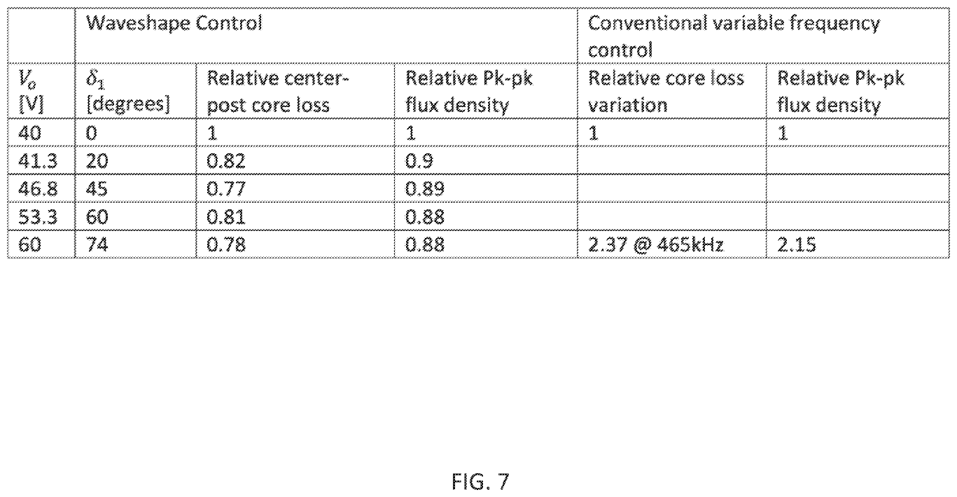

This can be a good metric, since the converter 204's loss cannot be optimized for a single maximum power operating condition. Instead, the entire voltage range needs to be considered. According to various embodiments, voltage-based losses (e.g., core losses) will be more dominant at the high-end of the wide voltage range, while current-based losses (e.g., conduction losses) will be more significant at the lower-end of the range. As a specific example, in some embodiments this quotient may be at least 1.2 (i.e., the upper limit 212 is at least 1.2 times the lower limit 214). In other embodiments, the quotient may be higher. See, for example, the simulation results shown in FIG. 7, which correspond to an upper limit 212 being 1.5 times the lower limit, at constant power (i.e., 3 KW). In still other embodiments, the quotient may be at least 1.8.

Other embodiments of the contemplated system 200 may be adapted for use with voltage ranges that fall outside this specific, non-limiting example of wide voltage ranges, or other definitions that characterize applications that fall outside the practical application of conventional circuits and devices (e.g., too bulky, too inefficient, etc.).

FIG. 3 is a schematic view of a non-limiting example of a Variable-Inverter-Rectifier-Transformer 202 structure. The Variable-Inverter-Rectifier-Transformer (VIRT) 202, as disclosed in U.S. patent application Ser. No. 16/312,071 (hereby incorporated by reference in its entirety), is a novel hybrid electronic and magnetic structure that integrates power converters directly into the windings of a transformer 102. This integration of converters, such as rectifiers, inverters, or even cycloconverters, with the magnetic structure enables new capabilities and degrees of freedom in the design of power converter transformers 102. Traditionally, a VIRT 202 is valuable in converters 204 having wide operating voltage ranges and high step-up/down, as it offers a means to reduce turns count and copper loss within a transformer 102 while facilitating voltage doubling and quadrupling, according to various embodiments.

A key feature of VIRT 202 is the ability to achieve true fractional turns ratios in the transformer 102. This is accomplished by incorporating multiple fractional windings on the magnetic core 300, such as half-turns or quarter-turns, and connecting converters to each fractional winding. By operating the converters in different modes, the effective transformer turns ratio seen by the rest of the power circuit can be reconfigured. For example, a VIRT 202 with two half-turn windings on the secondary side and full-bridge rectifiers connected to each can achieve effective turns ratios of 12:0.5, 12:1, or 12:2 depending on the rectifier switching patterns. This is a fundamentally new capability not achievable in conventional transformer designs.

The fractional turns facilitated by VIRT 202 provide the substantial benefit of enabling further reduction in transformer copper loss beyond what is possible with integer turns ratio designs. After reducing transformer turns to a single integer turn on one side, which is common practice, VIRT 202 allows further winding loss reduction through the use of fractional turns. This improved balancing of copper loss and core loss, by reducing the current carried in the winding, is highly advantageous for optimizing transformer efficiency.

Another key feature of VIRT 202 is the reconfigurability of the effective transformer turns ratio. By dynamically changing the operating mode of the incorporated converters, the effective ratio can be altered as needed. This facilitates the design of converters with wide operating voltage ranges 210, where large variations in conversion ratios normally lead to high stresses and poor efficiency. The reconfigurability of VIRT 202 makes it much easier to maintain high performance across wide voltage ranges 210.

Furthermore, VIRT 202 reduces conduction losses compared to prior emulated fractional turn designs by keeping the converter connections localized to each fractional winding. The AC currents remain confined to short paths encompassing the fractional turns, rather than having to conduct around the full perimeter of the core 300.

According to various embodiments, the VIRT 202 of the contemplated power conversion system 200 comprises four pairs of switches 308A-308D (i.e., pairs of switches Q1-Q8 in FIG. 3) forming four half-bridges 306A-306D, or a first rectifier 302 and a second rectifier 304. Each pair of switches 308A-308D having a top switch 310 and a bottom switch 312 with the top switch 310 being in one state of “on” and “off” and the bottom switch 312 being in the other state of “on” and “off”. It should be noted that this specific VIRT 202 architecture is a non-limiting example, and that other architectures exist. Other embodiments may employ variations on this non-limiting example of VIRT 202 structure, variations including, but not limited to, topology (e.g., 3-legged cores, 4-legged cores, shape of the core, etc.), number of converter cells (e.g., two rectifiers, four rectifiers, etc.), winding turns (e.g., half-turn, quarter-turn, third-turn, integer-and-a-half turn etc.), and the like.

The VIRT 202 has variable operating modes to assist with gain variation, but typically their focus has been on achieving wide operating voltages (and suffering the core losses associated with this wide range). However, the contemplated system 200 and method utilizes other modes of the VIRT 202 to manipulate a voltage waveshape 600 being fed into a converter 204 (e.g., an LLC converter 100), according to various embodiments.

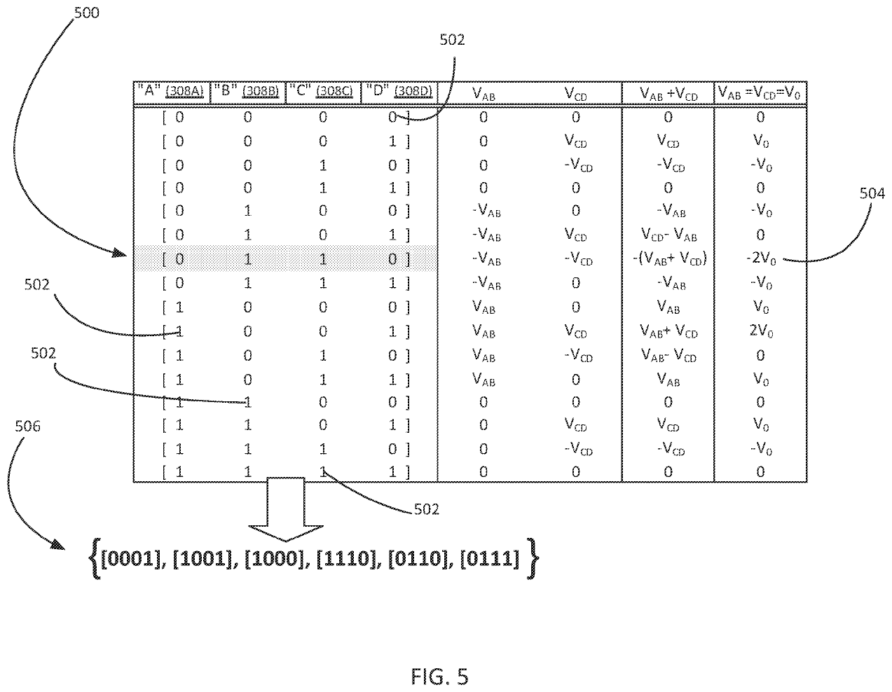

According to various embodiments, a VIRT 202 comprises a transformer 102 having a turns ratio and a magnetic core 300, and first and second rectifiers (302 and 304, respectively) coupled to a secondary side of the magnetic core 300. Each of the first rectifier 302 and second rectifier 304 comprise two half-bridges 306. In use, the first rectifier 302 operates at a first rectifier operating mode, and the second rectifier 304 operates at a second rectifier operating mode. According to various embodiments, the VIRTs 202 ability to modify the turn ratio is based upon these two modes. In the contemplated system 200, these modes are generalized into vectors 500, as will be discussed in the context of FIGS. 5 and 6, below.

As shown, the VIRT 202 may have two full-bridges distributed around a magnetic core 300. Switches Q1 and Q2 form a half-bridge pair 306A, also called “A” for convenience. Similarly, Q3 and Q4 form a half-bridge pair 306B or “B”, Q5 and Q6 form pair 306C or “C”, and Q7 and Q8 form pair 306D or “D”. These rectifiers are also associated with AC voltages 314A and 314B, labeled V_{AB} and V_{CD}.

As discussed above, conventional LLC converters 204 suffer from a widely varying core loss that limits efficiency and miniaturization when used in wide voltage range applications. Advantageously, the contemplated system 200 and method utilizes the flexible switching operation of the VIRT 202 in order to correct this core loss issue. According to various embodiments, the switches of the VIRT 202 are used to manipulate the applied voltage waveshape to achieve arbitrary waveshape control on the transformer 102, and then connecting this control to the gain of the transformer 102. This allows more favorable operating waveforms to be imposed on the transformer 102 over its wide gain operation, greatly mitigating its loss and making it simpler to design for high performance.

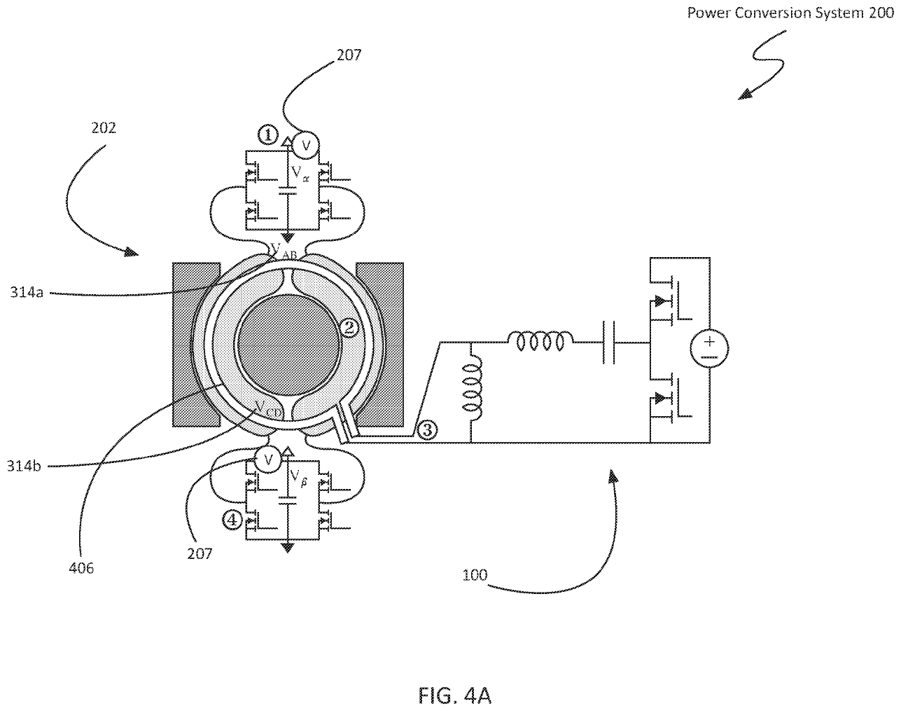

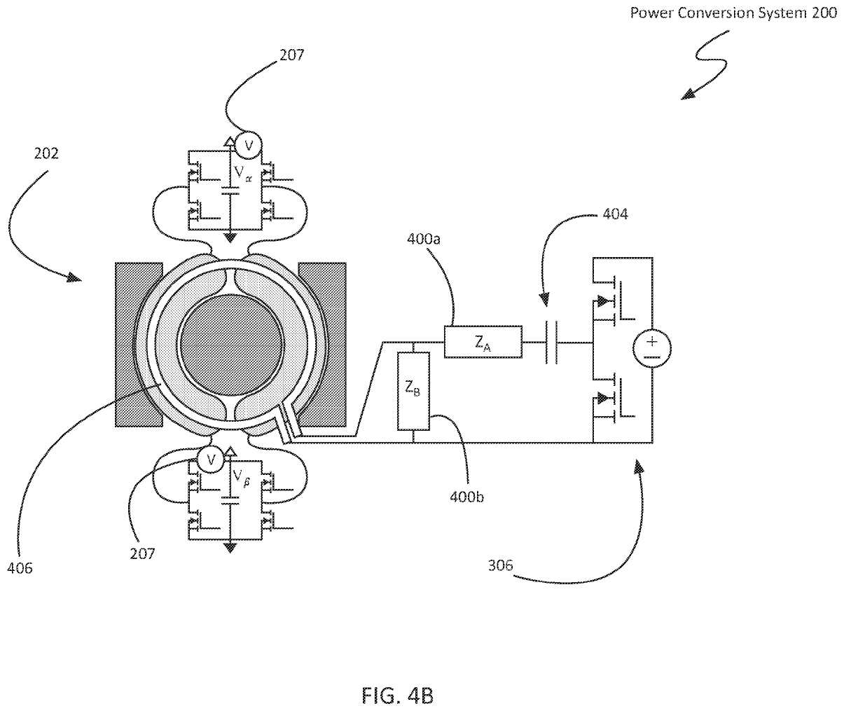

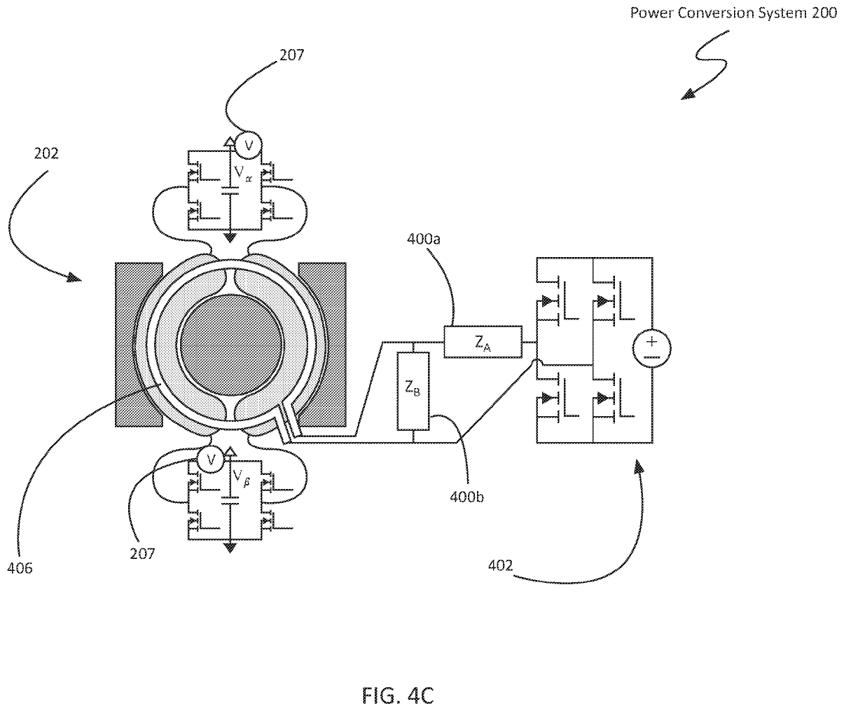

FIGS. 4A-4C are model circuit views of three non-limiting examples of a high efficiency wide-voltage-gain power conversion system, each comprising a converter 204 having at least one transformer 102. Specifically, FIG. 4A shows a model circuit view of a system 200 comprising a VIRT 202 circuit and an LLC converter 204. FIG. 4B shows a model circuit view of a system 200 comprising a half-bridge inverter 306 interfaced with a VIRT 202 through a blocking capacitor 404 and two impedances 400a and 400b. FIG. 4C shows a model circuit view of a system 200 comprising a full-bridge inverter 402 interfaced with a VIRT 202 through two impedances 400a and 400b.

Not shown in FIGS. 4A-4C is the additional circuitry needed to operate the switches. As is known in the art, a gate driver is connected to each switch to toggle them. A central controller generates voltage vectors (discussed below with respect to FIG. 5) and sends them to each gate driver, according to various embodiments. In some embodiments, the gate drivers may be individual to each switch, while in other embodiments the gate drivers may be implemented using a single IC connected to each half-bridge. Still other embodiments may employ any other method for operating such switches known in the art.

According to various embodiments, a method for wide-voltage-gain power conversion includes receiving an input voltage 207 at a Variable-Inverter-Rectifier-Transformer 202. See ‘circle 1’. It should be noted that while a VIRT 202 can interface with two voltages, V_{α} and V_{β}, here they are both interfaced with a single input voltage 207. In a specific, non-limiting embodiment, the VIRT 202 has four pairs of switches 308A-308D forming four half-bridges 306A-306D. Each pair of switches 308A-308D has a top switch 310 and a bottom switch 312. When the top switch 310 of a pair of switches is in one state 502 (i.e., either “on” or “off”), the bottom switch 312 of that pair is in other state 502 of “on” and “off”. As will be discussed in the context of FIG. 5, the states 502 of the four pairs of switches 308A-308D may be described by a vector 500.

Next, the VIRT 202 generates a voltage waveshape (e.g., the voltage waveshape 600 of FIG. 6). See ‘circle 2’. According to various embodiments, the voltage waveshape is generated by cycling the VIRT 202 through a sequence of vectors 506, as will be discussed with respect to FIGS. 5 and 6.

The voltage waveshape 600 generated by the VIRT 202 is applied to a converter 204 (e.g., the LLC converter 100 of FIG. 4A) that is communicatively coupled to the VIRT 202. See ‘circle 3’. According to various embodiments, the voltage waveshape 600 drives a controlled flux inside the center post of a transformer 102 belonging to the converter 204 such that an output voltage 208 is produced.

Finally, core loss is dynamically reduced within the transformer 102, across a wide voltage range 210 (e.g., input voltage 207, output voltage 208, or both), by modifying the length of at least one vector 500 in the sequence of vectors 506. See ‘circle 4’. Modifying the length or duration of one or more vectors 500 that make up the sequence of vectors 506 may alter the geometry of the voltage waveshape 600 such that a flux density within the transformer 102 of the converter 204 is reduced, also reducing core loss. As an option, in some embodiments, the modification of the length of one or more vectors 500 within the sequence of vectors 506 may be done without changing the period of the sequence of vectors' cycle. In other embodiments, the sequence of vectors 506 may be modified in other ways to manipulate the waveshape and, by extension, the flux density within the transformer 102.

While some embodiments employ an LLC converter 100, other embodiments may use other converter architectures. According to various embodiments, the contemplated system may be adapted for use with any converter structure which can be operated to enforce zero AC voltage on the transformer. For example, the non-limiting example shown in FIG. 4B achieves this using a half-bridge inverter 306 interfaced to a VIRT 202 through a blocking capacitor 404 and two impedances 400a and 400b, labeled Z_{A} and Z_{B}, respectively. These two impedances 400a and 400b represent an arbitrary connection of inductor, capacitor, and resistor elements. The non-limiting example shown in FIG. 4C does the same, here using a full-bridge inverter 402 interfaced to a VIRT 202 through two impedances 400a and 400b (i.e., Z_{A} and Z_{B}). It should be noted that in some embodiments, magnetic components of the converter 204 may be integrated into the transformer 102 of the VIRT(s) 202.

FIG. 5 is a table containing a plurality of vectors 500 that define various collections of switch states 502 of a non-limiting example of a VIRT 202 structure. The non-limiting example of a VIRT 202 structure shown in FIG. 3 has four pairs of switches, 308A-308D, that form four half-bridges 306A-306D. For each pair of switches, one switch is on and the other is off at a given moment. A vector 500 can be defined which has the state 502 of each of the 4 pairs of switches. By looking at the output voltages (which may also be referred to as segment voltages 504) for all possible vectors 500, it is possible to create a table showing all possible segment voltages 504, and from that table define sequences of vectors 506 to create a desired voltage waveshape 600.

The table shown in FIG. 5 contains all 16 possible states of the specific, non-limiting example of a VIRT 202 structure having four pairs of switches 308A-308D. As shown, the table indicates the state of each pair with a ‘1’, meaning the top switch 310 of that pair is “on” (thus making the bottom switch 312 “off”), or a ‘0’, meaning the top switch 310 of that pair is “off” (thus making the bottom switch 312 “on”). Those skilled in the art will recognize that these states could be enumerated with a wide variety of notations and methods. However, what is important is that all of the “VIRT states” (i.e., the collection of states for all switch pairs for a given moment) are known. Each of these “VIRT states”, which will hereinafter be referred to as vectors 500, has an associated segment voltage 504, which is the sum of the AC voltages across the first rectifier 302 and the second rectifier 304 of the VIRT 202, according to various embodiments having the architecture shown in FIG. 3. In other embodiments, the calculation may be different, but in the context of the present description and the claims that follow, a segment voltage 504 is simply the voltage output by a VIRT architecture for a specific set of simultaneous switch states.

In some embodiments of the VIRT 202 structure, the first rectifier 302 and the second rectifier 304 may be in parallel, such that their output voltages are equal. The segment voltages 504 resulting from such a scenario is shown in the final column of the table in FIG. 5. In the interest of simplifying the notation, the final column is recorded using the relation V_{AB}=V_{CD}=V₀. As shown, in that specific, non-limiting embodiment, the VIRT 202 can generate 5 different segment voltages 504: −2V₀, −V₀, 0, V₀, and 2V₀.

Conventional applications of this particular, non-limiting example of a VIRT 202 architecture have been focused on operation while in certain modes, identified by the table below:

| | | Full-Bridge / Half- | Half-Bridge/Half- | |
|---|---|---|---|---|
| | Full-Bridge/ | Bridge mode | Bridge mode | Half-Bridge/0 |
| Vector | Full-Bridge | (requires blocking | (requires blocking | mode (requires |
| Length | mode | capacitor) | capacitor) | blocking capacitor) |
| 50% | [1001] | [1001] | [1001] | [1000] |
| 50% | [0110] | [1000] | [0000] | [0000] |

It should be noted that these operating modes represent a small subset of the possible switching configurations. An enumeration of all the switching possibilities and related segment voltages 504 is shown in FIG. 5. Unlike previous applications of the VIRT 202 structure, the contemplated power conversion system 200 and method will make use of uncommon switching vectors 500 to create sequences of vectors 506, as discussed in the context of FIG. 6.

FIG. 6 is a plot of a single period 608 of a non-limiting example of a voltage waveshape 600 generated, and manipulated, by cycling a VIRT 202 through a sequence of vectors 506. Specifically, this voltage waveshape 600 is made up of the segment voltages 504 generated by a VIRT 202 structure being cycled through a sequence of vectors 506 (e.g., the six vectors 500 indicated beneath their segments of the plot of FIG. 6, etc.), repeating over a period 608. As previously discussed, every vector 500 of the complete set of enumerated vectors 500 (e.g., the table of FIG. 5) has an associated segment voltage 504. In the context of the present description and the claims that follow, a segment voltage 504 associated with a vector 500 is the voltage output by a VIRT 202 after the plurality of switches belonging to the VIRT 202 have been placed into the states 502 described by that vector 500.

According to various embodiments, the voltage waveshape 600 drives a controlled flux inside the center post of the transformer 102 of the connected converter 204. Advantageously, the voltage waveshape 600 can be modified by simply changing at least one of: the vector length 602 of at least one vector 500 of the sequence of vectors 506; the order of the vectors 500 belonging to the sequence of vectors 506; and/or which vectors 500 that make up the sequence of vectors 506, according to various embodiments. Changing one or more of these aspects can change the resulting voltage waveshape 600 in such a way that the flux being driven inside the transformer 102 leads to a beneficial change in behavior (e.g., reduction of core loss, etc.).

According to various embodiments, a sequence of vectors 506 contains at least two vectors 500. However, two vectors 500 would, at best, result in two segment voltages 504, limiting the voltage waveshape 600 to square waves, similar to conventional power conversion systems. In other embodiments, the sequence of vectors 506 may comprise more than two vectors 500. For example, in some embodiments, including the non-limiting example shown in FIG. 6, the sequence of vectors 506 may comprise at least six vectors 500.

Rather than focusing on the number of vector 500 in the sequence of vectors 506, in some embodiments the assembly of the sequence of vectors 506 may be constrained by the variety of associated segment voltages 504. For example, in some embodiments, the sequence of vectors 506 is associated with at least three different segment voltages 504 such that the voltage waveshape 600 is, or can be, multi-level (beyond a square wave).

In some embodiments, each vector 500 in the sequence of vectors 506 is unique. This may provide an advantage when cycling the VIRT 202 through the sequence of vectors 506, as it may allow the repetition of one or more segment voltages 504, without having to repeat a single particular set of switch states. As is known in the art, there can be benefits to lessening the sharp contrast between states (i.e., soft switching). As a specific example, in some embodiments, the sequence of vectors 506 is [0001], [1001], [1000], [1110], [0110], [0111]. These six unique vectors result in 5 different segment voltages 504. In other embodiments, one or more of the vectors 500 within the sequence of vectors 506 may be repeated more than once within a period 608.

When a VIRT 202 is cycled through a sequence of vectors 506, each vector 500 has a vector length 602 that determines the amount of time the VIRT 202 will spend in the particular state 502 defined by that vector 500 (i.e., the amount of time/fraction of the period 608 that the vector 500 is active). In some embodiments, the vector lengths 602 may be express as an amount of time. In other embodiments, the vector lengths 602 may be defined as fractions of the period 608 over which the sequence of vectors 506 is being cycled.

In some embodiments, the voltage waveshape 600 may be modified by changing the identity and/or order of the vectors 500 within the sequence of vectors 506. In other embodiments, the voltage waveshape 600 may be manipulated by changing one or more vector lengths 602. In some embodiments these changes in timing may be accompanied by changes in the period 608 over which the sequence of vectors 506 is cycled. In other embodiments, one or more vector lengths 602 may be modified while holding the period 608 constant, effectively emphasizing or deemphasizing portions of the voltage waveshape 600 while retaining, in a very general sense, the basic topology.

In some embodiments, the vector length 602 of one or more vectors 500 (i.e., segments of the voltage waveshape 600) may be modified independently. In other embodiments, two or more vectors 500 may change in length together. As a specific example, in the voltage waveshape 600 shown in FIG. 6, the first, third, fourth, and sixth vectors 500 of the sequence of vectors 506 all have a first length 604 (i.e., 81), and the second and fifth vectors 500 of the sequence of vectors 506 each have a second length 606 (i.e., one half the difference between the period 608 T and 4 times δ₁). According to various embodiments, the shape of the voltage waveshape 600 can be controlled by choosing the length δ₁ while keeping the period 608 (T) constant. When δ₁=0, the waveshape is identical to that of a conventionally operated LLC converter 204 with a VIRT 202 operating in the full-bridge/full-bridge (FB/FB) mode. For a fixed operation of the LLC's inverter, as δ₁ is increased, the voltage waveshape 600 takes on a piecewise sinusoidal shape, and the output voltage 208 of the system 200 increases. However, this also yields a waveshape with lower peak-to-peak flux density. The resulting flux density waveforms under different values of δ₁ is shown in the table of FIG. 7.

The core loss density associated with these piecewise linear waveforms can be explored using the improved general Steinmetz equation (iGSE), which yields

$${P}_{v} = {k}_{i} {( T [ 1 - \frac{{δ}_{1}}{180} ] )}^{β - α} {( \frac{{V}_{0}}{{NA}_{c}} )}^{β} [ \frac{{δ}_{1}}{90} ( 1 - {2}^{α} ) + {2}^{α} ]$$

N is the number of equivalent turns on the secondary (e.g., N equals 1 for the VIRT of FIG. 3) and Ac is the cross-sectional area of the center post. Re-arranging this equation to focus on waveshape elements yields

$$\frac{{P}_{v}}{{k}_{i}} \cdot {( {NA}_{c} )}^{β} \cdot {T}^{α - β} = {( 1 - \frac{{δ}_{1}}{180} )}^{β - α} {( {V}_{0} )}^{β} [ \frac{{δ}_{1}}{90} ( 1 - {2}^{α} ) + {2}^{α} ]$$

FIG. 7 is a table of simulated performance data for specific, non-limiting example of the contemplated system 200, to demonstrate its efficacy. Specifically, a simulation case study was performed for a 400V input, 40-60V output at 3 kW output power. It should be noted that this is the specification of version 2 of the Open Rack Standard. Part of the reason for moving away from this standard (in the newly proposed version 3) is because of concerns in designing a highly efficient converter for this operating regime, which is something the contemplated system 200 is well-adapted to accomplish. The results of this simulation study are shown in FIG. 7, assuming ML91S core material having α=2.15, and β=3.

As shown, the core loss varies by a factor of roughly 1.25 times, whereas in conventional systems the core loss varies by a factor of roughly 2.4 times. Furthermore, the peak-to-peak flux density is held within 12%, while in conventional control it increases by a factor of 2.15 times, further complicating design concerns.

As previously mentioned, in some embodiments, the cost of these benefits is an increase in conduction loss, which happens by introducing a higher current in the third harmonic. For example, in the worst case shown in FIG. 7, at δ₁=60°, the third harmonic is approximately one third the value of the fundamental current. The benefit of this harmonic shifting is that conduction losses go as I²R which means that for the same resistance seen by both harmonics, the third harmonic produces only one ninth the loss. Well-designed embodiments leverage the core loss reduction across the range of interest and account for this higher-harmonic loss to create a high efficiency, low volume design.

Where the above examples, embodiments and implementations reference examples, it should be understood by those of ordinary skill in the art that other wide-voltage-gain power conversion systems, methods and examples could be intermixed or substituted with those provided. In places where the description above refers to particular embodiments of a high efficiency wide-voltage-gain power conversion systems and methods, it should be readily apparent that a number of modifications may be made without departing from the spirit thereof and that these embodiments and implementations may be applied to other power conversion technologies as well. Accordingly, the disclosed subject matter is intended to embrace all such alterations, modifications and variations that fall within the spirit and scope of the disclosure and the knowledge of one of ordinary skill in the art.

What is claimed is:

1. A wide-voltage-gain power conversion system, comprising:
a Variable-Inverter-Rectifier-Transformer (VIRT) comprising four pairs of switches forming four half-bridges, each pair of switches having a top switch and a bottom switch with the top switch being in one state of “on” and “off” and the bottom switch being in the other state of “on” and “off”, the states of the four pairs of switches described by a vector belonging to a plurality of vectors, each vector of the plurality of vectors being associated with a segment voltage that is output by the VIRT; and
an LLC converter comprising a transformer, the transformer of the LLC converter communicatively coupled to the VIRT such that cycling the VIRT through a sequence of vectors having at least two vectors generates a voltage waveshape that drives a controlled flux inside a center post of the transformer;
wherein the VIRT receives an input voltage;
wherein the converter produces an output voltage;
wherein at least one of the input voltage and the output voltage varies across a wide voltage range;
wherein the wide voltage range is defined by an upper limit and a lower limit, with the upper voltage limit being at least 1.2 times the lower voltage limit and the converter carrying power that is substantially constant for all of the voltages in the wide voltage range.

2. The power conversion system of claim 1, wherein the sequence of vectors is associated with at least three different segment voltages such that the voltage waveshape is multi-level.

3. The power conversion system of claim 1, wherein the sequence of vectors comprises at least six vectors.

4. The power conversion system of claim 3, wherein each vector in the sequence of vectors is unique.

5. The power conversion system of claim 4, wherein the sequence of vectors is [0001], [1001], [1000], [1110], [0110], [0111].

6. The power conversion system of claim 5, wherein the first, third, fourth, and sixth vector of the sequence of vectors have a first length, and the second and fifth vectors of the sequence of vectors have a second length.

7. A wide-voltage-gain power conversion system, comprising:
a Variable-Inverter-Rectifier-Transformer (VIRT) comprising four pairs of switches forming four half-bridges, each pair of switches having a top switch and a bottom switch with the top switch being in one state of “on” and “off” and the bottom switch being in the other state of “on” and “off”, the states of the four pairs of switches described by a vector belonging to a plurality of vectors, each vector of the plurality of vectors being associated with a segment voltage that is output by the VIRT; and
a converter comprising at least one transformer, the at least one transformer of the converter communicatively coupled to the VIRT such that cycling the VIRT through a sequence of vectors generates a voltage waveshape that drives a controlled flux inside a center post of the at least one transformer;
wherein the VIRT interfaces with a first voltage;
wherein the converter interfaces with a second voltage;
wherein at least one of the first voltage and the second voltage varies across a wide voltage range.

8. The power conversion system of claim 7, wherein the converter is an LLC converter.

9. The power conversion system of claim 7, wherein the sequence of vectors is associated with at least three different segment voltages such that the voltage waveshape is multi-level.

10. The power conversion system of claim 7, wherein each vector in the sequence of vectors is unique.

11. The power conversion system of claim 7, wherein the sequence of vectors comprises more than two vectors.

12. The power conversion system of claim 7, wherein the sequence of vectors comprises at least six vectors.

13. The power conversion system of claim 12, wherein the sequence of vectors is [0001], [1001], [1000], [1110], [0110], [0111].

14. The power conversion system of claim 12, wherein the first, third, fourth, and sixth vector of the sequence of vectors have a first length, and the second and fifth vectors of the sequence of vectors have a second length.

15. The power conversion system of claim 7, wherein the wide voltage range is defined by an upper limit and a lower limit, the upper limit being at least 1.2 times the lower limit; and
wherein an output voltage is produced at a power that is substantially constant for all of the voltages across the wide voltage range.

16. The power conversion system of claim 7, wherein the wide voltage range is defined by an upper limit and a lower limit, the upper limit being at least 1.8 times the lower limit; and
wherein an output voltage is produced at a power that is substantially constant for all of the voltages across the wide voltage range.

17. The power conversion system of claim 7, wherein the first voltage is an input voltage received by the VIRT, and the second voltage is an output voltage produced by the converter.

18. The power conversion system of claim 7, further comprising:
a second VIRT communicatively coupled to the converter such that the converter interfaces with the second voltage through the second VIRT;
wherein the first voltage varies across a first wide voltage range;
wherein the second voltage varies across a second wide voltage range.

19. A method for wide-voltage-gain power conversion, comprising:
receiving an input voltage at a Variable-Inverter-Rectifier-Transformer (VIRT), the VIRT comprising four pairs of switches forming four half-bridges, each pair of switches having a top switch and a bottom switch with the top switch being in one state of “on” and “off” and the bottom switch being in the other state of “on” and “off”, the states of the four pairs of switches described by a vector belonging to a plurality of vectors, each vector of the plurality of vectors being associated with a segment voltage that is output by the VIRT;
generating a voltage waveshape by cycling the VIRT through a sequence of vectors, the voltage waveshape being composed of the segment voltage of each vector on the sequence of vectors, the sequence of vectors being cycled over a period, with each vector of the sequence of vectors being active for a length in the period;
applying the voltage waveshape generated by the VIRT to a converter, the converter communicatively coupled to the VIRT and comprising at least one transformer, wherein the voltage waveshape drives a controlled flux inside a center post of the transformer such that an output voltage is produced; and
dynamically reducing core loss within the transformer across a wide voltage range by modifying the length of at least one vector in the sequence of vectors, altering the voltage waveshape and thereby reducing a flux density within the transformer;
wherein at least one of the input voltage and the output voltage varies across the wide voltage range.

20. The method of claim 19, wherein the converter is an LLC converter.

21. The method of claim 19, wherein the sequence of vectors is associated with at least three different segment voltages such that the voltage waveshape is multi-level.

22. The method of claim 19, wherein each vector in the sequence of vectors is unique.

23. The method of claim 19, wherein the sequence of vectors comprises more than two vectors.

24. The method of claim 19, wherein the period is held constant during the modification of the length of at least one vector in the sequence of vectors.

25. The method of claim 19, wherein the sequence of vectors comprises at least six vectors.

26. The method of claim 25, wherein the sequence of vectors is [0001], [1001], [1000], [1110], [0110], [0111].

27. The method of claim 25, wherein the first, third, fourth, and sixth vector of the sequence of vectors have a first length, and the second and fifth vectors of the sequence of vectors have a second length.

28. The method of claim 19, wherein the wide voltage range is defined by an upper limit and a lower limit, the upper limit being at least 1.2 times the lower limit; and
wherein the output voltage is produced at a power that is substantially constant for all of the voltages across the wide voltage range.

29. The method of claim 19, wherein the wide voltage range is defined by an upper limit and a lower limit, the upper limit being at least 1.8 times the lower limit; and
wherein the output voltage is produced at a power that is substantially constant for all of the voltages across the wide voltage range.
